(19) United States
(12) Patent Application Publication
(10) Pub. No.: US 2007/0072489 A1
(43) Pub. Date: Mar. 29, 2007

(54) Method of installing semiconductor device manufacturing equipment and mock-up for use in the method

(76) Inventors: Kyung-Tae Kim, Suwon-si (KR); Jun-Woo Choi, Yongin-si (KR); Chul-Hwan Choi, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/402,822

(22) Filed: Apr. 13, 2006

(30) Foreign Application Priority Data
Sep. 26, 2005 (KR) 2005-0089075

(51) Int. Cl. H01R 13/66

(52) U.S. Cl. 439/620.09

(57) ABSTRACT

Semiconductor device manufacturing equipment is installed using a mock-up of the equipment. First, a full-scale layout drawing of the equipment is prepared. Also, a mock-up of the equipment is fabricated. The mock-up has wiring and pipe connectors of the same type as those of the main equipment. The layout drawing is placed on the floor of the site at which the main equipment is to be installed. Then the mock-up is placed at the same location where the main equipment is to be installed, as represented in the layout drawing, with the wiring and pipe connectors of the mock-up located at the same positions where the wiring and pipe connectors of the main equipment will be located. The wiring and piping of the semiconductor manufacturing equipment is installed, and ends of the wiring and piping are connected to the wiring and pipe connectors of the mock-up. Then the wiring and piping are inspected. Subsequently, the mock-up is disassembled and removed, and the main equipment is set in place at the same location from which the mock-up was removed. Finally, the wiring and piping are connected with the wiring and pipe connectors of the main equipment. Thus, the semiconductor device manufacturing equipment can be quickly placed in operation once the main, apparatus of the equipment is procured.

### BACKGROUND OF THE INVENTION

1. Field of the Invention

The present invention relates to a method of laying out and installing semiconductor device manufacturing equipment and to a mock-up of the layout.

2. Description of the Related Art

The manufacturing of semiconductor devices requires a high level of specialty and precision. In general, therefore, equipment for manufacturing semiconductor devices is very expensive.

Typically, a separate equipment manufacturing entity is commissioned to produce semiconductor device manufacturing equipment at the start of a production enterprise. However, before the semiconductor device equipment manufactured by this entity is installed, accessories and fixtures necessary for running the equipment are installed.

Specifically, semiconductor device manufacturing equipment typically does not consist of a single apparatus. Rather, semiconductor device manufacturing equipment comprises a series of processing apparatus for carrying out the numerous and varied processes required for manufacturing a semiconductor device. The processing apparatus each have a chamber in which a particular process is carried out on a substrate, namely a semiconductor wafer. Consequently, certain utilities must all be in place for running the semiconductor device manufacturing equipment. For example, many of the processing apparatus require that a processing gas be introduced into the chamber for processing the wafer. Also, the apparatus may require RF power for forming plasma using the processing gas. Still further, the semiconductor device manufacturing equipment requires electric power for operating the various apparatus. In particular, the semiconductor device manufacturing equipment has a controller, and electric power is supplied to the apparatus under the command of the controller. Finally, many of the processes carried out by the processing apparatus must be performed in a vacuum and at high temperatures. Thus, the semiconductor device manufacturing equipment requires vacuum lines connected to the processing chambers thereof, exhaust lines through which residual gases are exhausted from the process chambers immediately following the processes performed therein, and water supply lines through which pure water is supplied to the processing chambers for regulating the temperature of elements of the processing apparatus.

It takes a relatively long amount of time to install the incidental equipment required for operating the semiconductor device manufacturing equipment. Thus, the incidental equipment is installed before the processing apparatus of the semiconductor manufacturing equipment are acquired and set in place. Otherwise, the start-up of the semiconductor device manufacturing enterprise would be delayed considerably, resulting in large economic losses.

Thus, a layout of the semiconductor device manufacturing facility is produced before the semiconductor device manufacturing equipment is installed. First, a full scale two-dimensional layout drawing illustrating the positions where the apparatus of the semiconductor manufacturing equipment are to be installed is produced. Then the two-dimensional layout drawing is set on the floor of the site where the semiconductor device manufacturing equipment is to be installed. Subsequently, the incidental equipment, specifically, the various wires and pipes are installed in the ceiling of, on the floor of and in the ground of the manufacturing site (factory). That is, processing gas pipes, fuzzy gas pipes, vacuum lines, water supply lines, and electrical wiring and the like are installed in the ceiling, on the floor and in the ground of the manufacturing site. At this time, the ends of various ones of the wires, lines and pipes are set at locations vertically aligned with the locations at which wiring connectors, line connectors and pipe connectors of the processing apparatus will be positioned when such apparatus are set in place.

Finally, the apparatus of the semiconductor manufacturing equipment are set in place at positions indicated by the layout. Then, ends of the pipes are welded in place for connection to the pipe connectors of the semiconductor device manufacturing equipment. Specifically, the ends of the pipes are connected to nuts which form male or female ends of the pipe connectors. Thus, the ends of the pipe connectors can be uncoupled to check for any leaks or particles in the pipes after they are connected to the processing apparatus. Accordingly, a great deal of work must be performed once the processing apparatus of the semiconductor manufacturing equipment has been installed.

That is, it takes a large amount of time to connect and check each wire and pipe used in operating the semiconductor manufacturing equipment. As such, the installation costs are high, which costs must be passed on to the consumer of the semiconductor devices manufactured using the equipment.

### SUMMARY OF THE INVENTION

Therefore, an object of the present invention is to provide a method of installing semiconductor manufacturing equipment, which is capable of minimizing the time required for placing the equipment in operation once the main apparatus of the semiconductor device manufacturing equipment are procured.

According to one aspect of the invention, there is provided a method of installing semiconductor device manufacturing equipment in which a mock-up of the equipment is fabricated and installed before the main apparatus of the equipment.

First, a layout of the semiconductor device manufacturing equipment is produced. Preferably, the layout is a full-scale drawing of the main equipment. Also, a mock-up of the main equipment is fabricated. The mock-up includes wiring connectors and pipe connectors corresponding to those of the main equipment. The mock-up is set up on the installation site at a location where the main equipment is to be installed as represented in the layout. Then the wiring and piping of the semiconductor device manufacturing equipment is installed at the site. Subsequently, ends of the wiring and piping are connected with the wiring and pipe connectors of the mock-up. Next, the wiring and piping are inspected. The mock-up is removed once the inspection reveals that the connections are reliable and/or the interior of the piping is substantially free of particles. The main equipment is then installed at the location from which the mock-up was removed, and the wiring and piping are connected to the wiring and pipe connectors of the main equipment.

According to another aspect of the present invention, there is provided a component for use in the mock-up of the semiconductor device manufacturing equipment, wherein the component is modeled after a processing apparatus of the equipment. The component includes a shell, a post that maintains the shape of the shell, and wiring and pipe connectors. The shell has a base plate that forms the bottom of the shell, and wiring and piping connection plates forming sides and the top of the shell, respectively. The post extends from the base plate and supports the wire and piping connection plates. An electrical wiring connector is disposed on one of the wiring and piping connection plates and is exposed at the exterior of the shell to receive wiring of at least one power supply. One or more pipe connectors projects from at least one of the wiring and piping connection plates. Preferably, each pipe connector has a threaded end.

### BRIEF DESCRIPTION OF THE DRAWINGS

The above and other objects, features and advantages of the present invention will become more apparent to those of ordinary skill in the art from the following detailed description of the preferred embodiments thereof made with reference to the attached drawings in which:

FIG. 1 is a flowchart of a process of installing semiconductor device manufacturing equipment in accordance with the present invention;

FIG. 2 is a schematic side view of mock-up equipment in accordance with the present invention; and

FIG. 3 is a schematic side view of the mock-up equipment illustrating wiring and piping connected thereto in accordance with the present invention.

### DETAIELD DESCRIPTION OF THE PREFERRED EMBODIMENTS

Semiconductor devices are often produced by the semiconductor device manufacturing industry using semiconductor manufacturing equipment purchased from a separate entity dedicated to manufacturing such equipment. The semiconductor device manufacturing equipment usually includes a plurality of processing apparatus. This means that incidental equipment, i.e., various accessories and fixtures, must be provided to supply the apparatus with the service necessary for the apparatus to operate.

The incidental equipment includes conduit through which the service is delivered, e.g., conduit for wiring that supplies the electric power used to operate the equipment, conduit for the wiring that supplies the RF power used by a processing apparatus to form plasma, piping to deliver gas such as processing gas, cleaning gas and fuzzy gas to the processing chambers of the apparatus, piping to place the apparatus in communication with a vacuum source, and piping through which deionized (DI) water is delivered to the processing apparatus, etc.

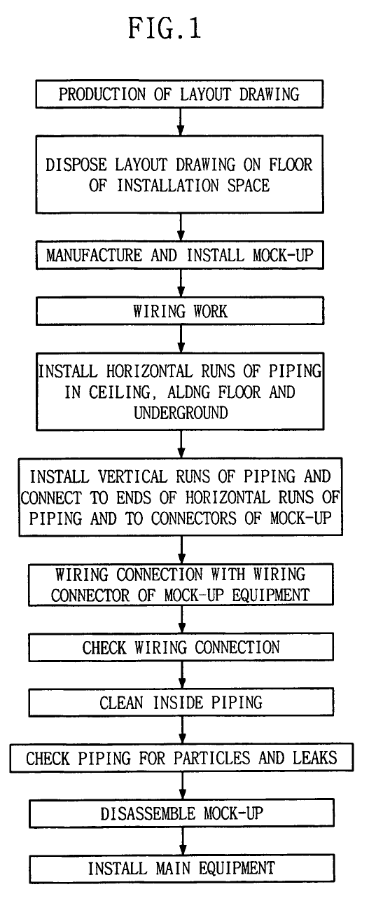

FIG. 1 is a flowchart of a process of installing such semiconductor manufacturing equipment in accordance with the present invention.

First, a drawing of the layout of the semiconductor manufacturing equipment, i.e., the main equipment and the wiring and piping for delivering service to the main equipment, is made. A manual provided by the equipment manufacturing company gives the locations of the wiring and piping appropriate for the space in which the main equipment is to be installed. Next, the layout drawing is placed on the floor of the installation space. This portion of the installation process is conventional.

However, unlike the conventional installation process, the present invention provides a mock-up which has the same basic size and configuration as the main equipment. More specifically, the mock-up includes a plurality of main components, corresponding to the various processing apparatus of the semiconductor device manufacturing equipment, and has means by which the components may be joined and separated from one another. Also, the components include wiring and pipe connectors having same form and disposition as those of the processing apparatus of the semiconductor device manufacturing equipment. Basically, the components of the mock-up are shells of the processing apparatus that include wiring and pipe connectors similar to those of the processing apparatus. Thus, the mock-up can be produced very quickly.

The components of the mock-up are positioned at the locations designated by the layout drawing. That is, the mock-up occupies the same space that will be occupied by the processing apparatus of the semiconductor device manufacturing equipment.

When the mock-up is safely in place at these locations, the necessary wiring and piping are installed in the ceiling, on the floor and in the ground of the installation site in accordance with the layout drawing.

The wiring is mostly disposed underground and along the floor of the installation site. The end of the wiring comprises a connection terminal by which the wiring can be simply connected with the wiring connectors of the mock-up.

As concerns the piping, the horizontal runs of the piping are first constructed such that ends of the horizontal runs are vertically aligned with piping connectors of the mock-up, respectively. Next, the vertical runs of the piping are constructed. First, one end of each vertical run of piping is welded to the end of a horizontal run of piping. Secondly, the other end of each vertical run of the piping is connected to a piping connector of the mock-up. More specifically, the free end of each vertical run of the piping is threaded to a piping connector of the mock-up. To this end, each vertical run of the piping is provided with a nut at its end. Each piping connector comprises a tubular portion having an external (male) thread, and the nut at the end of the vertical run of piping is threaded onto the tubular portion of the piping connector. Alternatively, the piping connector may comprise a nut. In this case, the end of the vertical run of the piping has a thread on its outer circumferential surface, and the nut of the piping connector is threaded to the vertical run of the piping.

Also, the insides of the pipes are cleaned and then inspected for any particles or leaks. The pipes may be cleaned and inspected each time a weld is formed or only after the entire system of piping has been fabricated. Similarly, the reliability of the connections of the wiring to the mock-up is checked.

Next, the mock-up is disassembled. First, the wiring and piping are disconnected from the mock-up. Then the mock-up is removed from the installation site. Finally, the main equipment is installed. Specifically, the processing apparatus are set in place in the spaces formerly occupied by the mock-up, and the piping and wiring are connected to the processing apparatus. Thus, the main equipment, once acquired, can be put into operation rather quickly by simply disassembling the mock-up and disposing the main equipment at locations corresponding to those at which the mock-up had been disposed. In other words, the present invention is characterized in that the wiring and piping which are necessary to supply the electric power, gas, vacuum pressure and DI water for operating the main equipment are installed ahead of the main equipment. Accordingly, the amount of time it takes to make the facility operational once the main equipment is procured is minimal.

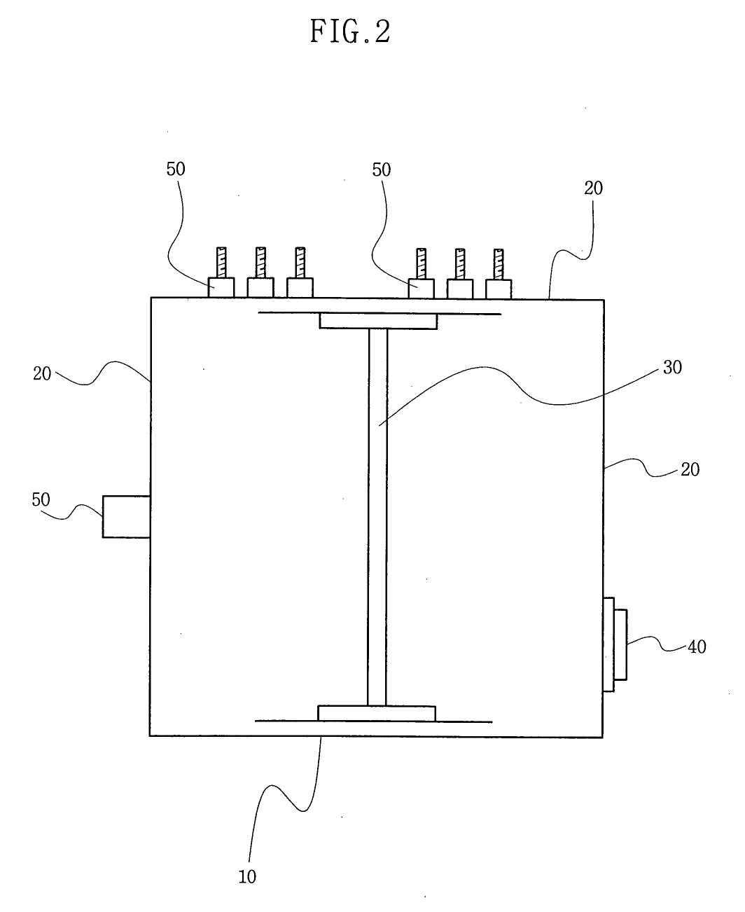

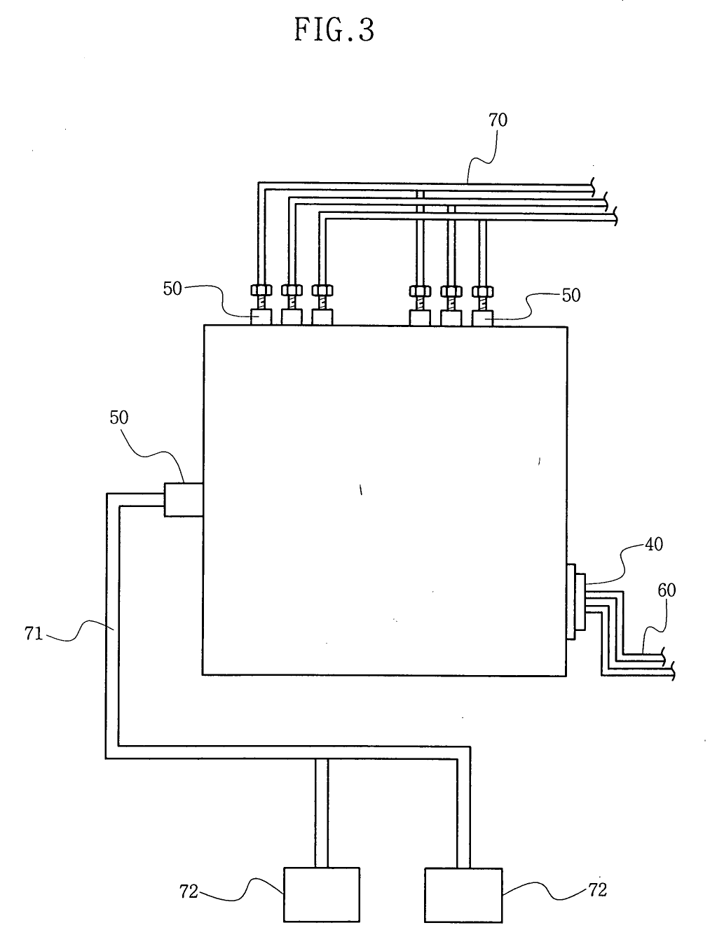

The mock-up of the present invention will now be described in more detail with reference to FIGS. 2 and 3. In this respect, only one component of the mock-up will be illustrated and described for the sake of brevity but, as mentioned above, the mock-up will generally includes several of such components and preferably these components include means by which the components can be joined and separated from one another.

Each component of the mock-up in accordance with the present invention comprises a base plate 10, wiring and piping connection plates 20, a post 30, an electrical wiring connector 40 and pipe connectors 50, as illustrated in FIG. 2.

The base plate 10 may have the same area as that of the bottom of a processing apparatus of the main equipment or an area which is smaller than that of the bottom of the processing apparatus but is capable of at least safely supporting the remainder of the structure. The wiring and piping connection plates 20 form the top and sides of the structure. The plates 20 which form the sides of the structure have the same height as the sides of a processing apparatus of the main equipment.

The post 30 extends between the base plate 10 and supports the wiring and piping connection plates 20. Specifically, the post 30 extends to the wiring and piping connection plate 20 that forms the top of the structure, and serves to maintain the basic shape of the shell formed by the base plate 10 and the wiring and piping connection plates 20.

The wiring and pipe connectors 40 and 50 are mounted to the wiring and piping connection plates 20 preferably at locations corresponding to those at which the wiring and pipe connectors of a processing apparatus of the semiconductor manufacturing equipment will be disposed when such apparatus is installed. Part of the wiring connector 40 projects from a wiring and piping connection plate 20 to receive wiring 60 through which electric power and RF power are supplied. Each pipe connector 50 has a threaded portion, e.g., a male or female thread for mating with a threaded end of the piping 70 and 71 through which various gases, water and vacuum pressure are supplied, respectively.

As mentioned previously, once the mock-up is manufactured and installed, the wiring 60 through which electric power and RF power are supplied and the piping through which various gases, pure DI water and vacuum pressure are supplied are installed in the ceiling, on the floor and in the ground of the installation site.

More specifically, the two cables of the wiring 60 are disposed along the floor of the installation site and parts of these cables sometimes lie under ground. Therefore, the wiring connector of a processing apparatus is located near the ground. Thus, the wiring connector 40 of the mock-up is disposed at the bottom of a wiring and piping connection plate 20 adjacent the base plate 10 to receive the end of the wiring 60.

The processing apparatus also typically receive gases, such as processing gas, fuzzy gas and cooling gas through the top portions thereof. Therefore, the piping 70 through which the gases are supplied are mostly installed in the ceiling of the installation site. Accordingly, pipe connectors 50 are provided on the wiring and connection plate 20 forming the top of the mock-up to receive ends of the piping 70. On the other hand, although not limited, the piping through which pure DI water is supplied to and the piping through which gases are exhausted from a processing apparatus typically run through the ground of the installation site. Thus, pipe connectors 50 are also provided on one or more of the connection and wiring plates 20 that form the sides of the mock-up. FIG. 3 shows the piping 71 through which gases are exhausted and the pipe connector that receives an end of the piping 71. The piping 71 is connected with one or more vacuum pumps 72 such that a vacuum can be created in a processing chamber of the corresponding processing apparatus and residual gases remaining in can be forcibly discharged therefrom after a particular process is carried out in the chamber.

In accordance with the present invention as described above, a mock-up of the main apparatus of the semiconductor manufacturing equipment is produced and installed before the main apparatus are installed. The mock-up has wiring and pipe connectors of the same type as those of the main apparatus, and the mock-up is installed with its wiring and pipe connectors disposed at locations where the corresponding connectors of the main apparatus will be located when the main apparatus are installed. Accordingly, the wiring for supplying power, the piping for supplying various gases and pure DI water and the piping for exhausting the gases can be installed while the main apparatus are being procured. In addition, the wiring and piping can be connected with the wiring and pipe connectors of the mock-up and checked for their reliability. Thus, once the main equipment is procured, the mock-up is simply removed, the main equipment is installed at those locations from which the mock-up has been removed, and the wiring and piping is simply connected to the wiring and pipe connectors of the main equipment. As a result, the main equipment can be quickly installed and put into operation. This provides a great advantage of time savings in connection with the installation and thus lowers the production costs incurred from the time of undertaking the manufacturing enterprise.

Finally, although the present invention has been described above in connection with the preferred embodiments thereof, it is understood that the scope of the invention is not so limited. On the contrary, various modifications and alternative arrangements of the preferred embodiments will be apparent to those skilled in the art. Therefore, modifications and variations of the preferred embodiments are within the true spirit and scope of the invention as defined by the appended claims.

What is claimed is:

1. A method of installing semiconductor device manufacturing equipment, comprising:
producing a layout of the semiconductor device manufacturing equipment for an installation site, wherein the semiconductor device manufacturing equipment comprises a plurality of pieces of main equipment having wiring connectors and pipe connectors, and wiring and piping connected to the main equipment via the wiring and pipe connectors, respectively;
providing a mock-up of the main equipment, wherein the mock-up includes wiring connectors and pipe connectors corresponding to those of the main equipment;
positioning the mock-up on the installation site at a location where the main equipment is to be installed as represented in the layout;
installing wiring and piping at the installation site;
connecting ends of the wiring and piping with the wiring and pipe connectors of the mock-up;
inspecting the wiring and piping while the ends thereof connected to the wiring and pipe connectors of the mock-up;
subsequently removing the mock-up from said location; and
subsequently positioning the main equipment at said location, and connecting the wiring and piping to the wiring and pipe connectors of the main equipment.

2. The method according to claim 1, wherein the connecting of ends of the piping with the pipe connectors of the mock-up comprises threading the ends of the piping to the pipe connectors of the mock-up.

3. The method according to claim 1, wherein the producing of a layout of the semiconductor device manufacturing equipment comprises producing a full scale drawing of the layout of the main equipment, and further comprising setting the full scale drawing on the floor of the installation site before the mock-up is installed.

4. The method according to claim 1, wherein the inspecting of the wiring and piping comprises checking the piping for leaks.

5. The method according to claim 1, wherein the inspecting of the wiring and piping comprises checking for particles within the piping.

6. A component for use in a mock-up of semiconductor manufacturing equipment, comprising:
a shell including a base plate forming the bottom of the shell, and wiring and piping connection plates forming sides and the top of the shell, respectively;
a post extending from the base plate and supporting the wire and piping connection plates;
an electrical wiring connector disposed on one of the wiring and piping connection plates and exposed at the exterior of the shell and configured to receive wiring of at least one power supply; and
a respective pipe connector that projects from at least one of the wiring and piping connection plates.

7. The component as claimed in claim 6, wherein each said pipe connector has a threaded end.

8. The component as claimed in claim 6, wherein a plurality of the pipe connectors project upwardly from the wiring and piping connection plate that forms the top of the shell.

9. The component as claimed in claim 6, wherein the electrical wiring connector is disposed on one of the wiring and piping connection plates that forms a side of the shell, at a lower portion thereof adjacent the base plate.
